(19) United States
(12) Patent Application Publication
(10) Pub. No.: US 2019/0323275 A1
(43) Pub. Date: Oct. 24, 2019

(54) FOLDING BARN STYLE DOOR AND HARDWARE

(71) Applicant: Robert M. Stell, Simi Valley, CA (US)

(72) Inventor: Robert M. Stell, Simi Valley, CA (US)

(21) Appl. No.: 16/255,068

(22) Filed: Jan. 23, 2019

Related U.S. Application Data
(60) Provisional application No. 62/621,846, filed on Jan. 25, 2018.

(51) Int. Cl. E05D 15/48; E05D 15/26; E06B 3/50

(52) U.S. Cl. CPC E05D 15/48; E05D 15/264; E05Y 2900/132; E05D 2015/485; E06B 3/5072

(57) ABSTRACT

A folding sliding door that uses a track and exposed rotating rollers attached to a series of door panels whereby the door panels can fold while the exposed rotating rollers roll along the track, thereby permitting the appearance of a sliding barn door.

### FIELD OF INVENTION

The present invention is for a folding and sliding door having panels that give the appearance of a barn door type closure that uses an exposed track and rollers mounted on the wall above the opening to be covered by the door panels. The typical barn door type closure has a track mounted above the opening to be closed and a single door panel that has U-shaped rollers attached to the top edge of the door panels whereby the door panels can move along the track to open and close the opening. The track extends beyond the width of the opening to be covered.

### BACKGROUND OF THE INVENTION

Barn door type closures are very popular. A barn door type closure is a single solid door panel that has exposed rollers at the top of the door panel that slide in an exposed track. There are prior art foldable doors that has a track with a recess located along the top of the door frame. The door panels are hinged to one another along one of their vertical sides and have pins located at the outside top edges of the door panels that fit within the recesses in the track permitting the door panels to pivot at their hinges while the pins slide along the recessed track. This type of opening closure does not have the appearance of a barn door type closure and is restricted to the width of the frame of the opening to be covered.

A single F. R. Myers barn door hanger (shown in FIG. 1A) has been attached to the top of a single barn door connected to a second barn door by hinges along their vertical length. The second barn door is hinged along its vertical edge to the frame of the barn. The two connecting doors fold outwardly as the hanger is moved along the track. The two doors do not slide parallel to the barn opening. (See FIG. 1B.)

Other prior art systems that simulate barn door appearance have a track and rollers, but the rollers are connected to an accordion type door so that a complicated arrangements of pivotable members are required to permit the folding of the accordion segments. Further, the accordion segments do not do not go beyond the door opening. This roller and attachment does not permit the use of solid door panels. (See U.S. Pat. No. 9,322,203.) Further, the rollers are hidden inside the U-shaped track.

### SUMMARY OF THE INVENTION

To replace an existing door with a barn door type closure requires substantial modification of the door assembly, particularly if the door is to be used to cover a closet. Further, if the sliding door assembly is to fit in a track, the length of the track must be twice the length of the width of the opening to be covered and uncovered.

The present invention has the appearance of a conventional barn door type closure, with an exposed track above the opening and rotating exposed rollers attached to the front and top edge of multiple door panels. Instead of a single door panel, the device of the present invention has a series of door panels that are hinged along one vertical edge of two adjacent door panels so that they can fold at the same time that they move along the exposed track above the opening.

The present invention can be used for any width opening, such as a room opening, a door opening, as an enclosure around a bathtub or shower or for shutters rather than a solid door panel. The size of the opening will determine the width of the individual panels. The associated track can be either the size of the opening to be covered, or the track can extend beyond the width of the opening so that the door panels do not need to fold at their hinged portions, but can slide as one piece along the track. Alternatively, the door panels can slide along the track and also be folded along the hinge portions at the side of the door opening to be covered. Further, more than 2 door panels can be used with the present invention if desired.

The present invention can be used for closing high or wide openings of premises such as hangars, garages, warehouses, and the like, as well as indoor closets, bath/shower enclosures, windows, and wall openings. The invention enables the closing and openings to be effected more easily and quickly, at the same time insuring the strength and rigidity of the parts and of the whole door structure. An opening can be open in its entirety. It is particularly useful when there is a restriction on the amount of space on the side of the openings, such as for use with closets in homes.

While in the preferred embodiment the door is a solid member, it is possible to use louvers 70 for covering a window, instead of curtains or conventional louver covers.

### OBJECTS OF THE INVENTION

It is an object of the present invention to provide an improved folding door assembly that is simple to install.

Another object is to permit an attractive door, simulating a barn door;

Another object is to permit the folding door to be used in a restricted space on the sides of the opening;

These and other objects will be apparent from the review of accompanying drawings and the specification.

### BRIEF DESCRIPTION OF THE DRAWINGS

FIGS. 1A-B shows prior art mechanisms. FIG. 1A is a door hanger connecting a roller pivotally connected to a bracket to be mounted to the top of the door;

FIGS. 1C-D shows prior art mechanisms in which a single door panel is sliding within the track above the opening; FIG. 1C is in a closed position and FIG. 1D is in an open position;

FIGS. 2A-D shows the door of the present invention permitting the rollers to stay in the track, and at the same time for the door panels to slide and fold. FIG. 2A is in a fully closed position and FIG. 2B and FIG. 2C show the doors in an intermediate position and FIG. 2D shows the doors in a fully open position;

FIGS. 3 show a perspective view of the hardware for permitting the sliding of the U-shaped roller in the track and the sliding of the door panels;

FIG. 4 shows a front view of the exposed rollers and track attached to the top edge of the door panels;

FIG. 5 shows a front view of the hardware with the dimensions of the components of the hardware;

FIG. 6 show a side view of the hardware with the dimensions of the components of the hardware;

FIG. 7 shows a perspective view of a floor mounted bottom pin that fits within a recessed hole in the bottom of one of the hinged-pair of doors;

FIG. 8 is an alternative embodiment of the door panels in which shutter doors are shown;

FIG. 9 is a top front of an alternative embodiment of the folding door;

FIG. 10 is a front view of an alternative embodiment of the folding door;

FIG. 11 is a front sectional view of the floor bracket with removable pin removed used with the alternative embodiment; and

FIG. 12 is a side sectional view of the floor bracket with removable pin used with the alternative embodiment.

### DETAILED DESCRIPTION OF THE INVENTION

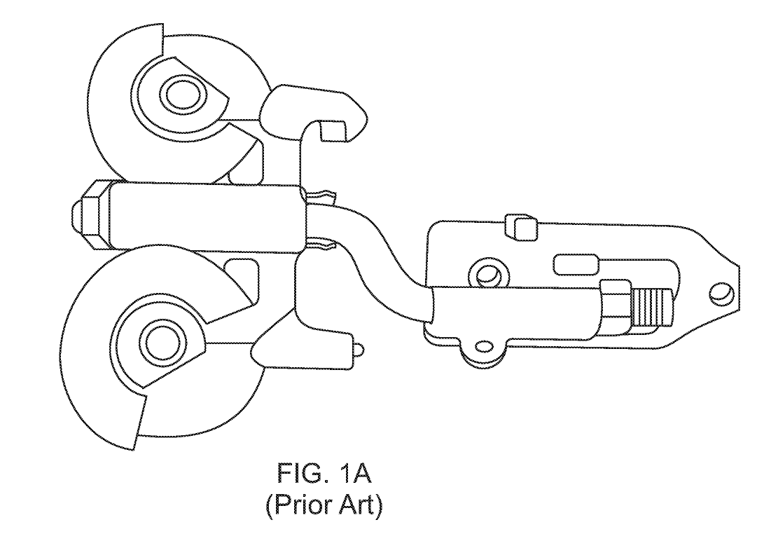

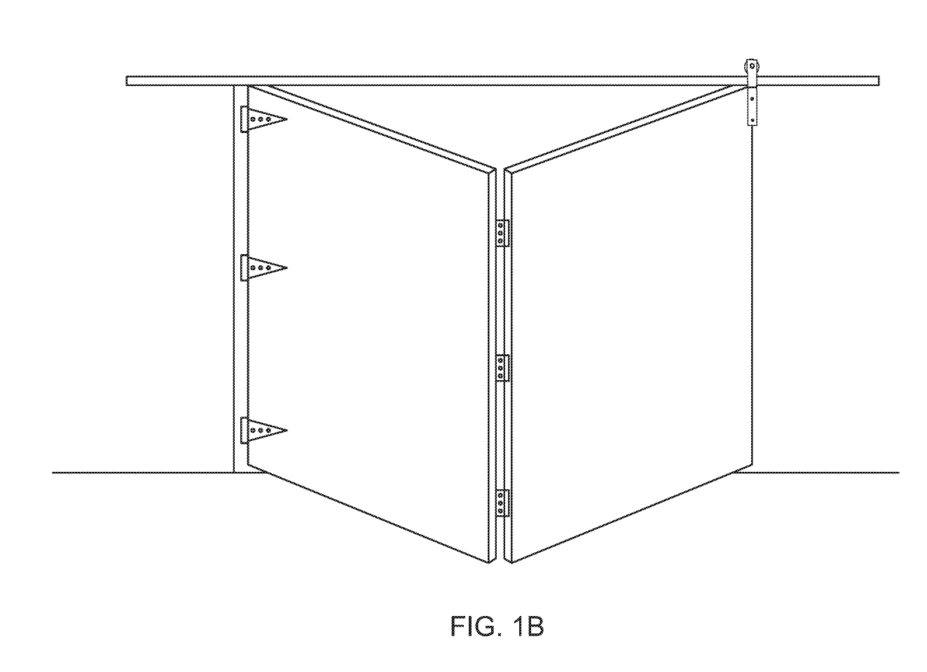

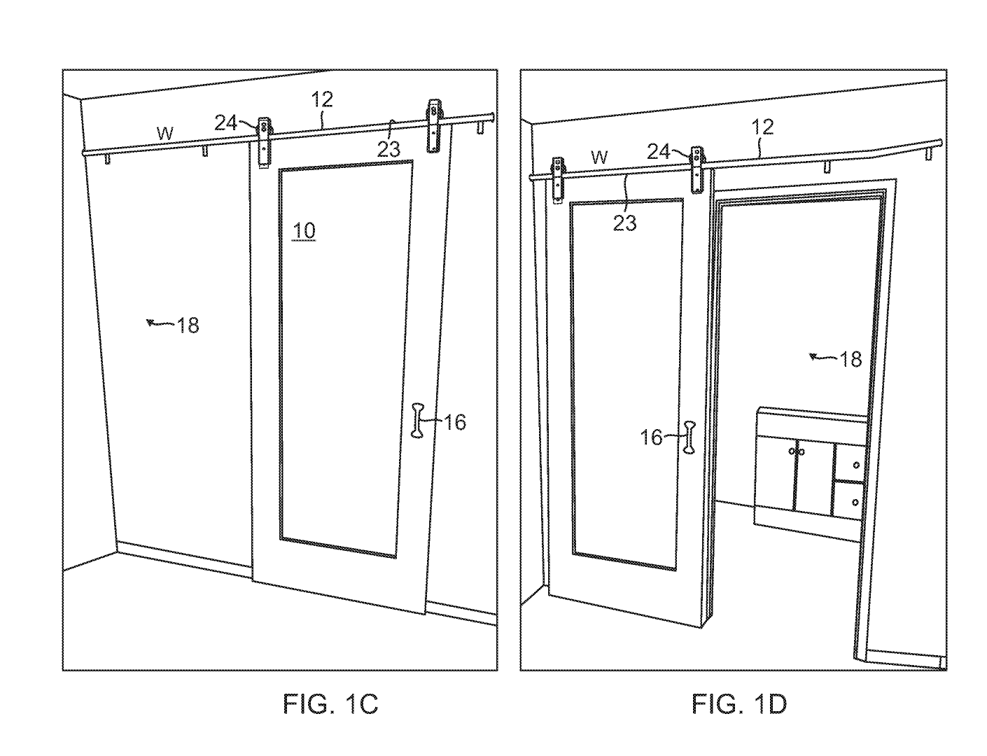

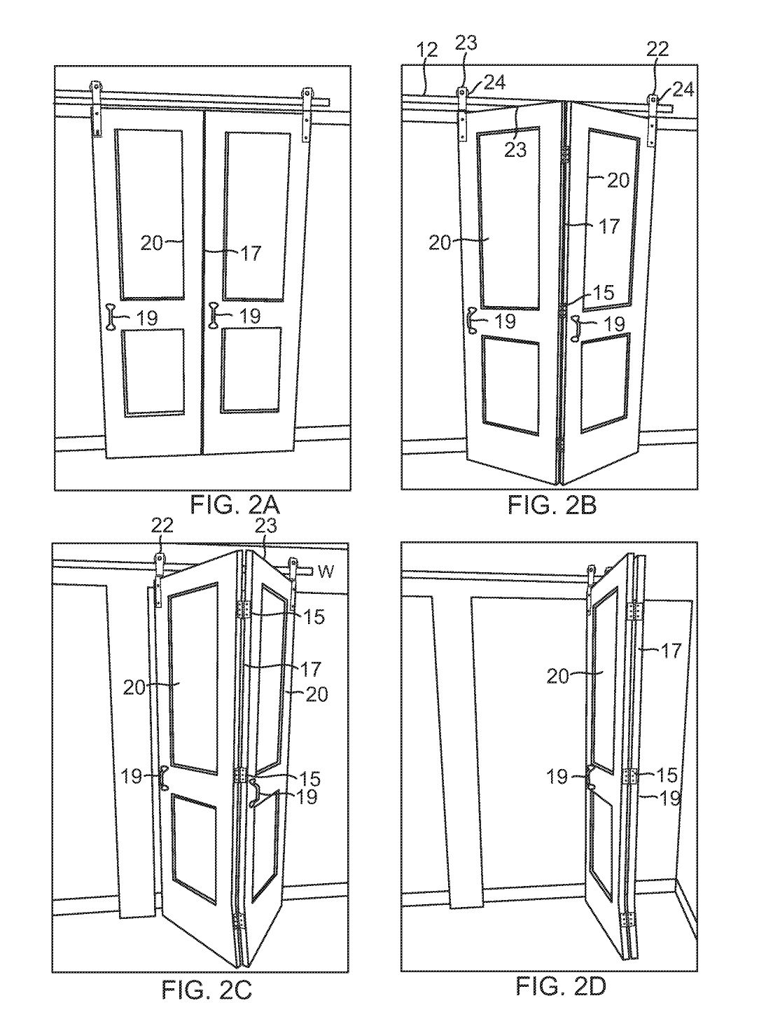

Referring to FIGS. 2A-2D, door panels 20 are shown hinged together along their vertical sides 17 so as to be foldable. Each door panel 20 has a width one half or more of the opening to be covered. FIG. 2A shows a fully closed position while FIG. 1D shows a fully open position. FIGS. 2B and 2C show the door panels 20 in intermediate positions.

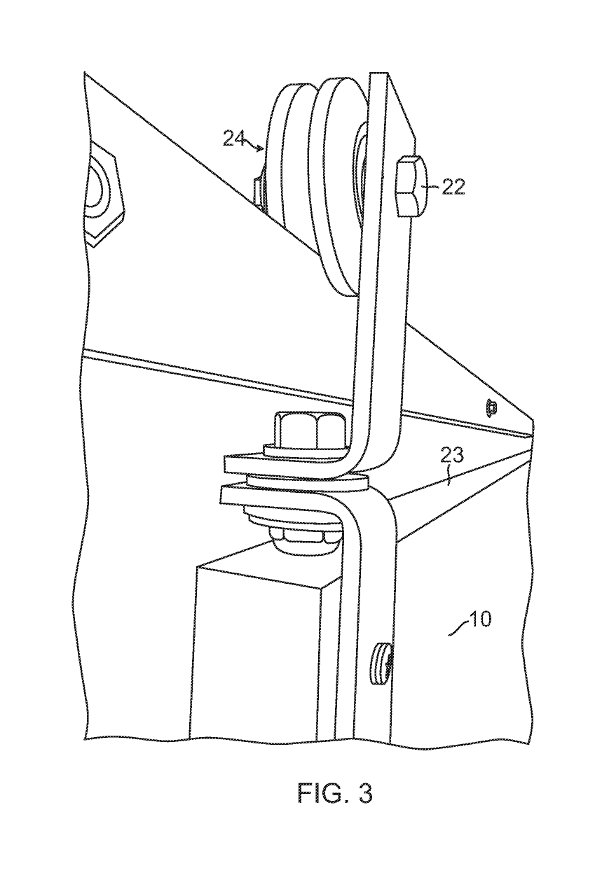

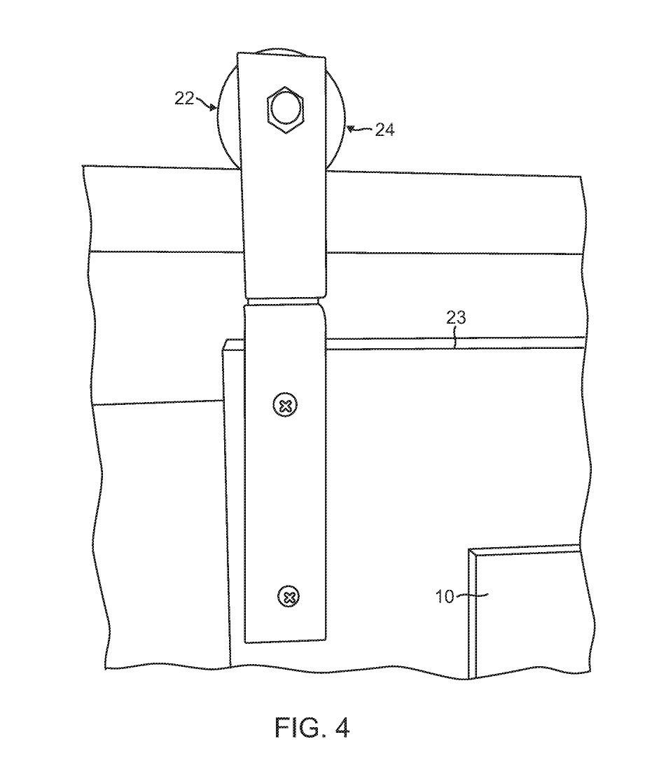

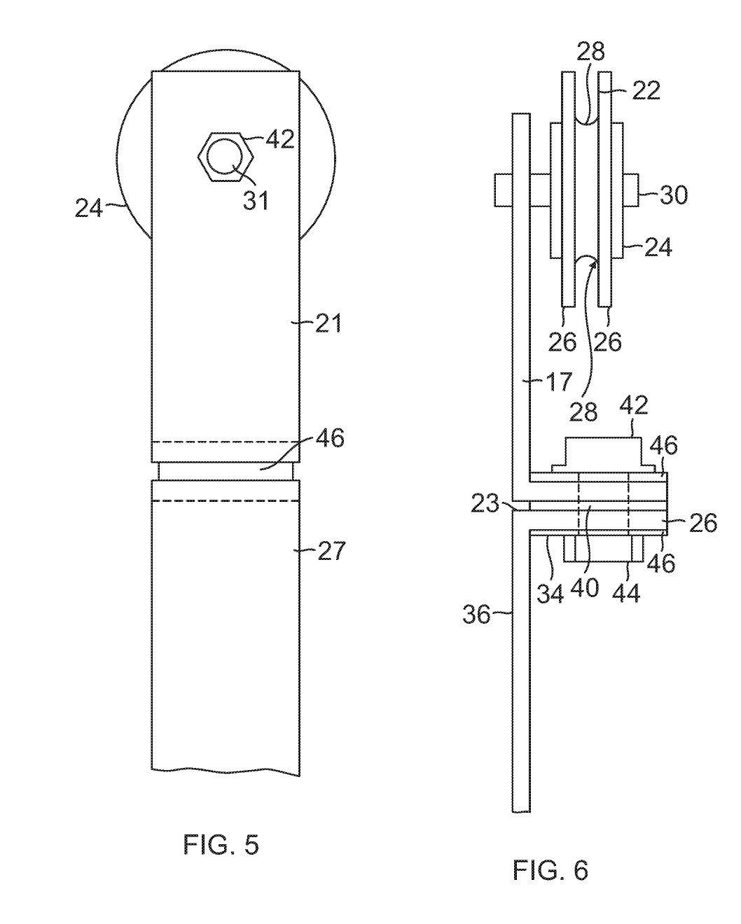

Each of the door panels 20 has a U-shaped roller assembly 22 pivotally attached to the top edge 23 of each door panel 20. The construction and preferred dimensions of the rotating exposed roller assembly 22 is shown in FIGS. 5 and 6. The door panels 20 can be pushed to be completely on the side of the opening by having the track 12 extending to the side of the opening.

The rotating exposed roller assembly 22 consists of a standard U-shaped roller 24 having two opposing round members 26 with an internal taper 28 in between, a pivotable pin 30 connected to the center of the U-shaped roller assembly 22 that permits the U-shaped roller 24 to pivot about its central pin 30. In the preferred embodiment, the pin 30 is connected to a flat L-shaped attachment bar 32 having an upper vertical segment 21 at the bottom horizontal leg 34. The bottom leg 34 of the L-shaped attachment bar 32 is pivotally attached to L-shaped attachment bar 36 having a vertical segment 27 and horizontal leg 34 connected to the top edge 23 of the door panel 20 by means of a pin 40 passing through the bottom leg 34 of L-shaped attachment bar 32 and the top leg 42 of the L-shaped attachment bar 36. The pin 40 is held in place by nut 42 and bolt 44 and washers 46. A metal pivot or swedge could be used in lieu of nut and bolt as shown.

It is possible to use a single flat attachment rod for attaching the roller assembly to the door. In typical use a pair of doors would each have a roller assembly attached and each door in its closed position would cover a portion of the opening, closet or window. Typically, each door would be the same size, approximately a little larger than ½ of the width of the opening.

In operation, starting with the door panels 20 in the initial closed position as shown in FIG. 2, the handles 19 are grasped and pushed in a direction parallel to the wall. The U-shaped roller assembly 22 moves in the track 12 mounted above the door panels 20. As shown in FIGS. 2B-2D, the door panels 20 pivot pin 40 connecting the door panels 20 to the U-shaped roller assembly 22 mounted on the top outside ends of each of the door panels 20 opposite the vertical hinged portion of the door panels 20 permitting the door panels to fold along the hinges 15 connecting the door panels 20.

If the track extends beyond the opening to be covered, such as shown in FIGS. 2A-2D, then the door panels 20 can be slid along the track without folding of the door panels 20. Alternatively, the door panels can be folded and moved along the tack to a position to the side of the opening and even be used to cover an adjacent opening,

To add stability to the door panels 20 when sliding along the track 12, an upwardly or depending floor mounted round pin 40 can be mounted at the bottom outer ends of one panel of the hinged pair of doors 20. The pin would fit within a depression in in the bottom of one door panel 20 so that the pin restricts movement of the door panels 20 away from the wall and in alignment with the upper track distance from the wall.

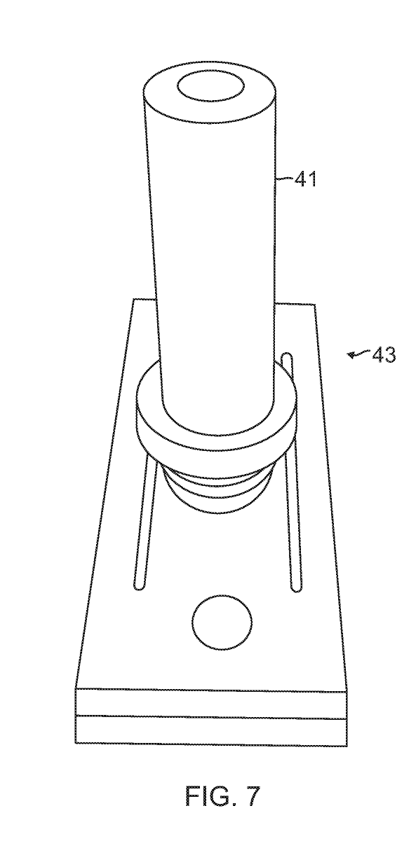

Referring to FIG. 8, instead of solid door panels 20, any shape of door panels 60, such as louvered 70 or shutters can be used. Also, instead of a door opening in a wall, the present invention can be used for opening and covering windows, bathtubs, showers, where there is an opening to be covered.

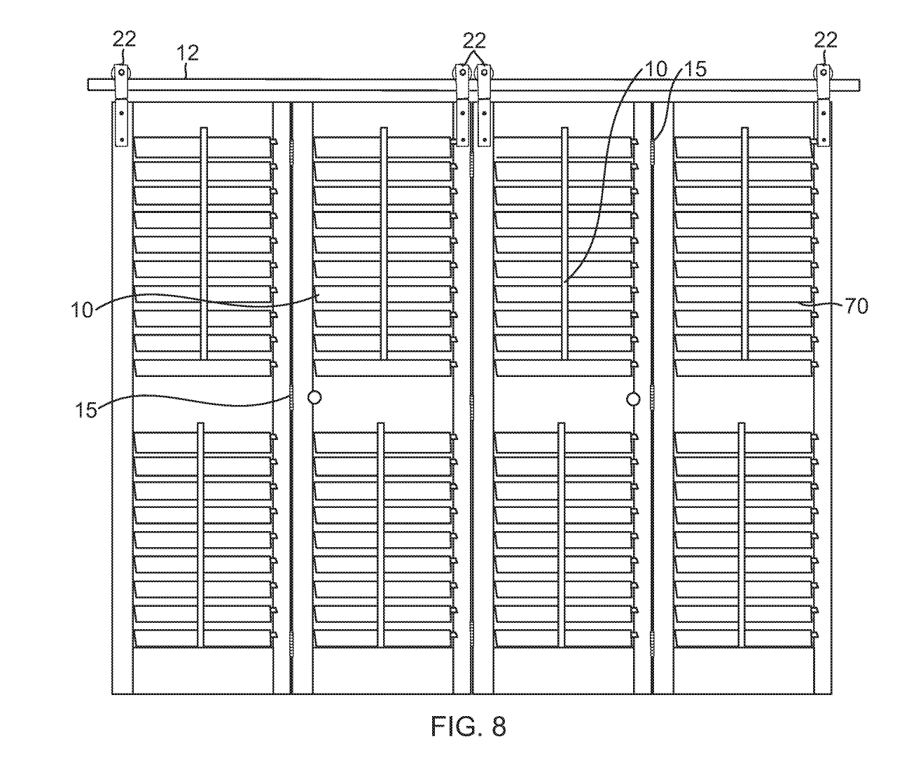

Referring to FIGS. 9-12, an alternative embodiment of the present invention is shown where the doors can fold in place and have the added option of the doors sliding like a conventional barn door hardware system.

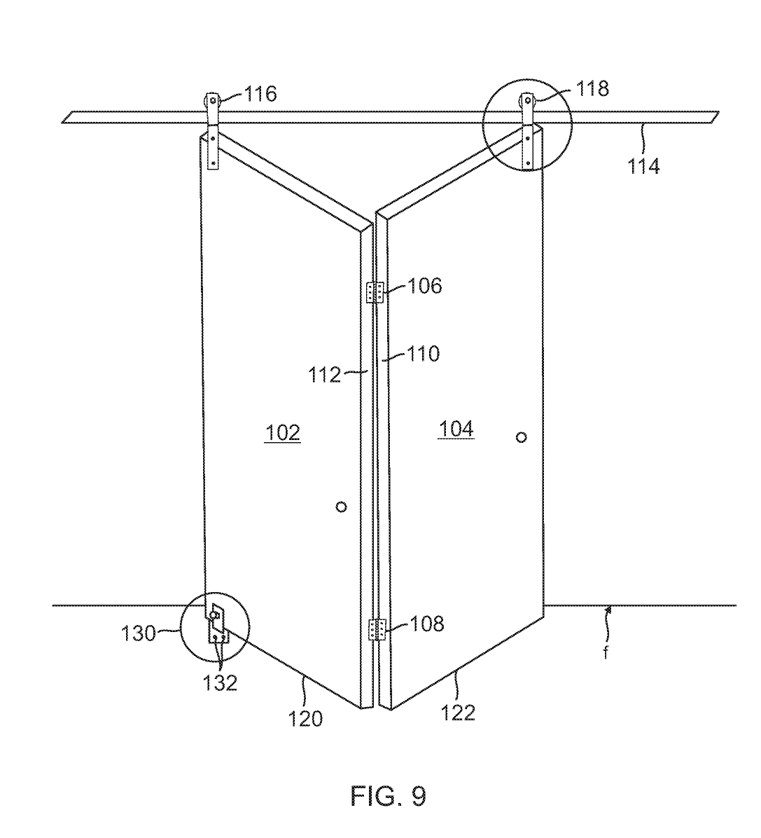

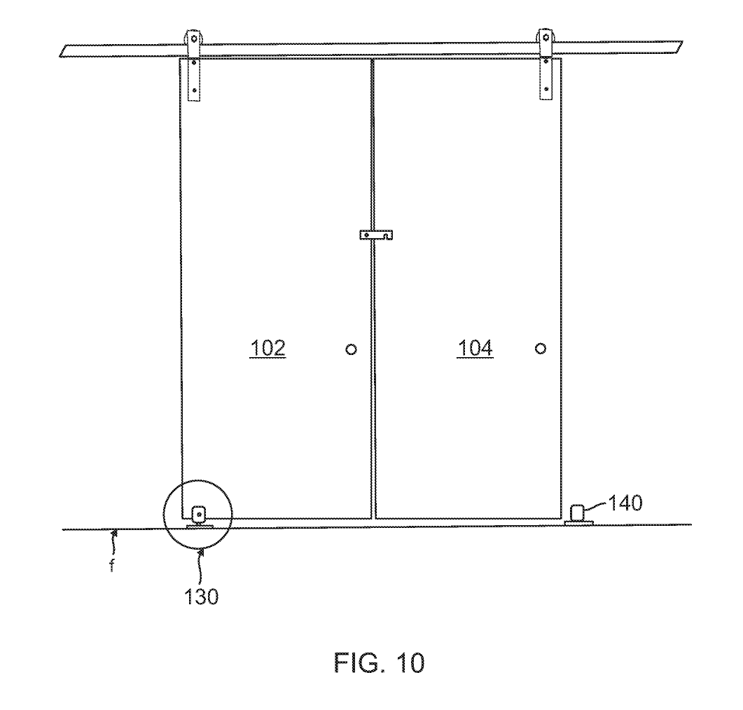

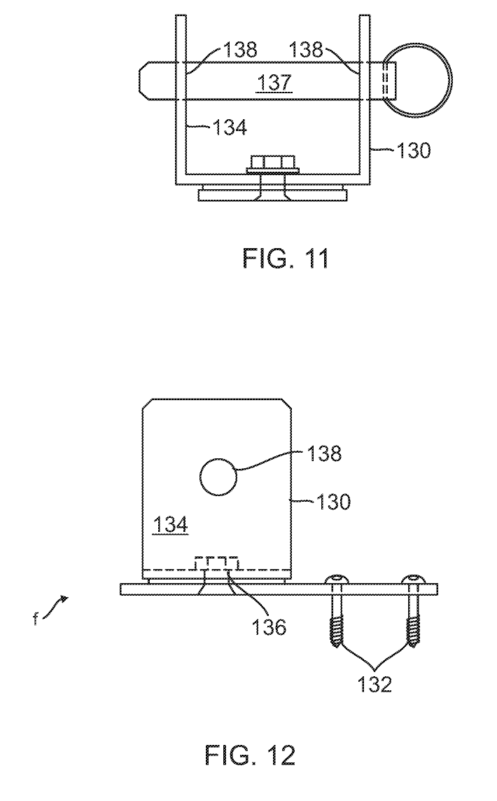

The two doors 102 and 104, connected by hinges 106 and 108 along their side edges 110 and 112 described previously are mounted on the upper track 114 by rollers 116 and 118 as in the prior version. The lower portions 120 and 122 of the two doors is attached to a bracket 130 connected to the floor (F) by screws 132 (FIGS. 9 and 10). The bracket 130 has a lower U shaped portion 134 with a central pivot member 136 allowing rotation of the lower bracket about the pivot member 136. There is a removable pin 137 (passing through openings 138) through the side walls 134 of the U Shaped bracket 130 that is removable, as shown in FIG. 12. The dimensions of the bracket 130 are shown in FIGS. 11 and 12. When the doors are going to slide without pivoting, as shown in FIG. 9 the pin 137 is removed and when the doors are pivoted only as in FIG. 10, the pin is in place.

Alternatively, a single track can be provided along the length of the floor, with a single pin depending from the bottom of the door that fits within a slot in the track and can move laterally in the guide or pivot within the guide when the doors are to be pivoted.

A fixed non-pivoting floor guide 140 is mounted on the floor (F) remains parallel with the wall for the sliding door function.

The benefits of this alternative embodiment are: 1. Doors can slide to the left or right of the wall opening like a standard barn door system (sliding distance depends on the length of the track) 2. By inserting a removable metal pin in the floor guide, the door can fold as described in the original patent 3. Where a pair of folding doors is hanging on the same upper track: Both doors can slide, both doors can fold, or one door can slide and the other door can fold 4. When floor guide is in the sliding position, and the door slides in the opposite direction of the combination floor guide, an additional standard fixed floor mounted guide should be installed

While the invention has been described in connection with certain preferred embodiments, it is not intended to limit the scope of the invention to the particular forms set forth, but, on the contrary, it is intended to cover such alternatives, modifications, and equivalents as may be included within the spirit and scope of the invention as defined by the appended claims.

What is claimed is:

1. A folding door system comprising at least two doors; the two doors connected along a vertical edge by hinges; at least a pair of brackets at least one of which is connected to the top of each of said doors; such brackets having rollers at the top for engaging a track, a plate at the bottom for attachment to the top of the door and an intermediate segment for permitting pivotal movement of the plate in relationship to the rollers.

2. The system of claim 1 in which the bottom ends of at least one of the doors is pivotally connected to the floor to permit lateral movement of the doors.
